(19) United States
(12) Patent Application Publication
(10) Pub. No.: US 2020/0393251 A1
(43) Pub. Date: Dec. 17, 2020

(54) INDOOR NAVIGATION

(71) Applicant: Sonarax Ltd., Haifa (IL)

(72) Inventors: Guy Shofen, Kiryat Bialik (IL); Benny Saban, Haifa (IL)

(73) Assignee: Sonarax Ltd., Haifa (IL)

(21) Appl. No.: 16/946,244

(22) Filed: Jun. 11, 2020

Related U.S. Application Data
(60) Provisional application No. 62/860,251, filed on Jun. 12, 2019.

(51) Int. Cl. G01C 21/20; G01S 15/89

(52) U.S. Cl. CPC G01C 21/206; G01S 15/8979

(57) ABSTRACT

A method for determining indoor position of a mobile device, the method may include (i) receiving, by the mobile device, acoustic beacon signals transmitted from indoor transmitters of known location; wherein adjacent indoor transmitters transmit acoustic beacon signals of different frequencies, the different frequencies are selected out of a group of frequencies within an acoustic frequency range that starts above 15 Kilohertz, and (ii) determining a location of the mobile device within an indoor space, based on a mapping between (a) locations within the indoor space, and (b) acoustic signatures associated with the locations, wherein each acoustic signature comprises a frequency and an intensity parameter of acoustic beacon signals received at a location associated with the acoustic signature.

### CROSS REFERENCE

This application claims priority from U.S. provisional patent 62/860,251 filing date Jun. 12, 2019 which is incorporated herein by reference.

### BACKGROUND

There is a growing need to provide an efficient solution for indoor navigation.

### SUMMARY

There may be provided a method for determining indoor position of a mobile device, the method may include receiving, by the mobile device, acoustic beacon signals transmitted from indoor transmitters of known location; wherein adjacent indoor transmitters transmit acoustic beacon signals of different frequencies, the different frequencies are selected out of a group of frequencies within an acoustic frequency range that starts above fifteen Kilohertz; and determining a location of the mobile device within an indoor space, based on a mapping between (a) locations within the indoor space, and (b) acoustic signatures associated with the locations, wherein each acoustic signature may include a frequency and an intensity parameter of acoustic beacon signals received at a location associated with the acoustic signature.

The method may include generating, by the mobile device, a location indication based on the determining of the at least location; wherein the generating may be executed even when the mobile device does not execute, at the time of the generating, a navigation application.

The method may include determining a movement parameter of the mobile device based on Doppler shifts of the acoustic beacon signals.

The method may include searching for a sign change of a Doppler shift associated with an acoustic beacon signal transmitted by a certain indoor transmitter.

The method may include determining that the mobile device passed over the certain indoor transmitter when the sign change of the Doppler shift occurred.

The method may include starting to search for an acoustic beacon signals transmitted from the certain indoor transmitter following an occurrence of the sign change of the Doppler shift.

The method may include transmitting by the mobile phone location information and acoustic signature received by the mobile phone during at least a part of a duration within the indoor space.

There may be provided a non-transitory computer program product for determining indoor position of a mobile device, the non-transitory computer program product stores instructions for: receiving, by the mobile device, acoustic beacon signals transmitted from indoor transmitters of known location; wherein adjacent indoor transmitters transmit acoustic beacon signals of different frequencies, the different frequencies are selected out of a group of frequencies within an acoustic frequency range that starts above fifteen Kilohertz; and determining a location of the mobile device within an indoor space, based on a mapping between (a) locations within the indoor space, and (b) acoustic signatures associated with the locations, wherein each acoustic signature may include a frequency and an intensity parameter of acoustic beacon signals received at a location associated with the acoustic signature.

The computer program product may store instructions for generating, by the mobile device, a location indication based on the determining of the at least location; wherein the generating may be executed even when the mobile device does not execute, at the time of the generating, a navigation application.

The computer program product may store instructions for determining a movement parameter of the mobile device based on Doppler shifts of the acoustic beacon signals.

The computer program product may store instructions for searching for a sign change of a Doppler shift associated with an acoustic beacon signal transmitted by a certain indoor transmitter.

The computer program product may store instructions for determining that the mobile device passed over the certain indoor transmitter when the sign change of the Doppler shift occurred.

The computer program product may store instructions for starting to search for an acoustic beacon signals transmitted from the certain indoor transmitter following an occurrence of the sign change of the Doppler shift.

The computer program product may store instructions for transmitting by the mobile phone location information and acoustic signature received by the mobile phone during at least a part of a duration within the indoor space.

### SUMMARY

There may be provided a method for indoor navigation within an indoor space. The indoor space is mapped so that different locations within the indoor space have unique acoustic signatures that provide information about one or more acoustic beacon signals that should be received at these locations. A user may move within the indoor space and his location may be determined based on the mapping and the currently received acoustic beacon signals.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a mobile device; and

FIG. 3 illustrates an example of indoor navigation.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

The terms frequency and tone are used in an interchangeable manner. The terms indoor transmitter and beacon transmitter are used in an interchangeable manner and refer to a transmitter that is configured to transmit acoustic beacon signals within an indoor space.

Unlike traditional methods for indoor navigation, which consistently finding the current position of the device, the suggested solution assists in indoor navigation by finding the current position of the device at the beginning of the navigation and from there on, determining the relative movement of the device (speed and direction). Also, in order to compensate on accumulated errors, the current position will also be found at specific locations.

The description in this document will not include the method for finding the initial position, but only the methods for determining the relative movement of the device and for finding the current position at specific locations.

It is assumed that the current location, before navigation begins, is known. The current location may be determined in various manners—for example using GPS or other out of door reliable methods—when the current location is near an exit from the indoor environment, triangulation, standing at a known location that may be even physically marked, and the like.

The solution may require (i) a user device (such as but not limited to a mobile phone) with a microphone, a man machine interface and a processing circuit and (ii) Ultrasonic beacon transmitters (speakers) that were deployed at the indoor structure, (iii) the indoor structure and it's deployed beacon transmitters tones have been mapped, (iv) the required software (capable of executing at least some of the steps listed below) is installed on the user device.

Each beacon transmitter may be configured to transmit (playing) one or more tones out of the available predefined tones. The frequency difference between different adjacent tones may be the same or may differ from one pair of adjacent frequencies to the other. If more than one tone is included in the acoustic beacon than these tones may be transmitted simultaneously.

For example:

a. Tones starts at −18 KHz (above human hearing range).
b. Tones ends at −21 KHz (to support user device microphones)
c. Tones are gapped by ˜150 Hz from each other.

The distance between the beacon transmitters may range from a few meters to a few tens of meters—for example between 10 meters to 30 meters. Other distances may be used. For example—the distance may be determined based on the dimensions of the indoor space. The distance may be a fraction of the length or width of the indoor space.

Adjacent beacon transmitters may require different frequencies, but reusing frequencies is possible and necessary for covering large venues. The reuse may be implemented on beacon transmitters that are far enough from each other so that the beacons from different beacon transmitters of the same frequency have, per location, a significant difference in intensity to that only one beacon is strong enough at the location.

The beacon transmitters are not necessarily omnidirectional and may transmit in one direction. When two directions are required, two beacon transmitters are deployed.

Once the preconditions and requirements are fulfilled, the following method may be performed

According to the current position of the user device and the mapping of the beacon transmitters tones, the two nearest beacon transmitters in each direction are being determined. Since the estimated location is known and the area is mapped, the nearest beacon transmitters are also known. Therefore, the user device may calculate the movement according to the two closest ones in each direction. This also provides a smooth transition when the user device approaches and passes a beacon transmitter. The nearest beacons may be the strongest beacons received by the user device. It should be noted that the method may include determining the location of a single nearest beacon transmitter or the locations of more than two nearest beacon transmitters.

Using the user device microphone, audio data is being captured.

Captured data may be analyzed in the following manner:
a. For each out of the tones (that are being transmitted by the two nearest beacon transmitters in each direction), the shift in frequency, which is caused by the Doppler effect (due to movement of the user), is calculated. Using the shift frequency in each of the tones, and the known/estimated relative location of each beacon transmitter from the user device, the movement direction and speed (movement of the user) are being calculated. It should be noted that a dedicated tone may be allocated for Doppler shift measurements. The dedicated tone is of a known frequency that is not used for positioning. A mobile device may determine its Doppler shift based on the transmission frequency of the dedicated tone and the received frequency-shifted version of the dedicate tone.
b. When the user device get very close to the beacon transmitter, the user device may wait to identify a switch in the shift direction, which is caused by the user device passing the beacon transmitter (audio source) and changing the relative movement from moving toward it to moving away it.
c. The shift in direction is represented by a shift in the Doppler effect—from moving towards the beacon transmitter to moving away from the beacon transmitter.
d. When the switch in the shift direction of the nearby beacon transmitter has occurred, the user device identifies it the point where the user device has passed the beacon transmitter and begins listening to the next beacon transmitter (two in total) in that direction.
e. If the current estimated location of the user device on the map is not correlated with the identification of passing the beacon transmitter, the user device is adding the required fix to its speed calculation, throughout the following few seconds to create a smooth correlation between the estimated position and the actual position.

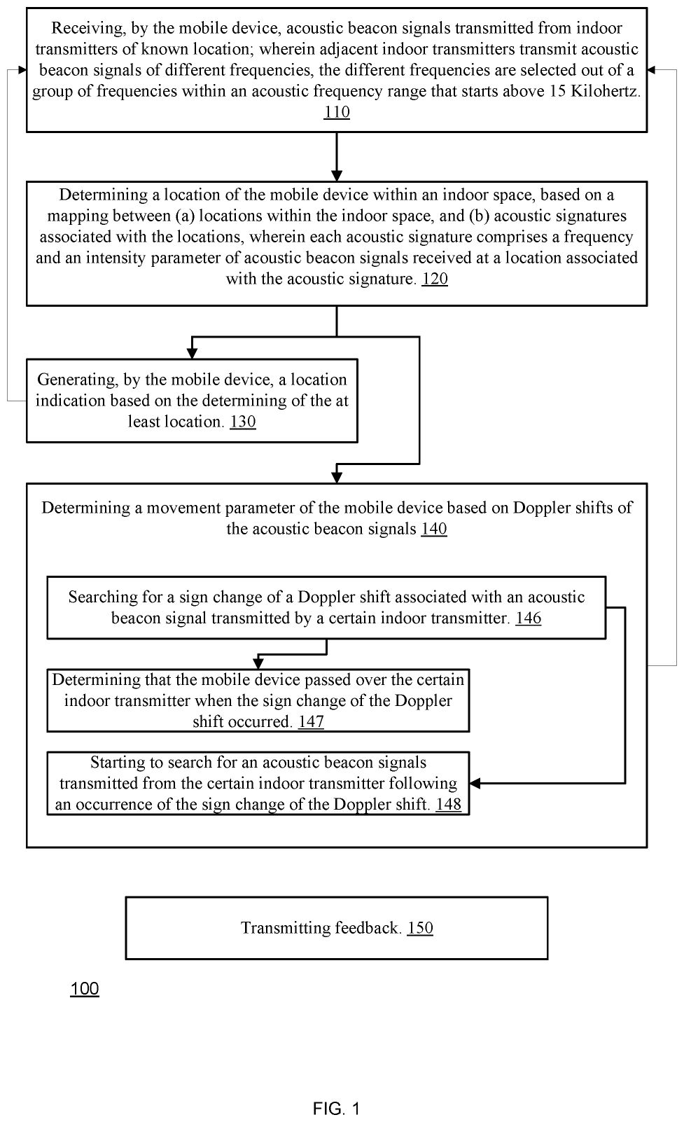

FIG. 1 illustrates an example of method 100.

Method 100 may be for determining indoor position of a mobile device.

Method 100 may start by step 110 of receiving, by the mobile device, acoustic beacon signals transmitted from indoor transmitters of known location. The indoor transmitters are located within the indoor space and are either fixed or have a known location even if they are moved.

It is beneficial to allocate the frequencies of the acoustic beacon signals of different indoor transmitters so that at each location of the indoor space a mobile device will receive up to a single acoustic beacon signal per frequency.

Accordingly—adjacent indoor transmitters may transmit acoustic beacon signals of different frequencies. An acoustic beacon signals may be a single tone or may include a combination of multiple tones. It may be beneficial that at a certain location only one indoor transmitter uses a certain frequency. It should be noted that the mobile device may also receive a dedicated tone allocated for Doppler shift measurements.

The indoor transmitter may transmit acoustic beacon signals out of a group of frequencies within an acoustic frequency range that starts above 15 Kilohertz (or any other predefined threshold)—as it beneficial to transmit the acoustic beacon signals (a) within a range that can be detected by microphones of mobile devices that are also used to sense speech (so there is no need to have an additional microphone for receiving the acoustic beacon signals), and (b) within a higher end of the 0-20 Khz range—so that most people will not hear the acoustic beacon signals.

The acoustic beacon signals may be detected at a relatively short distance from the indoor transmitters—such as few meters to few tens of meters (for example between 15-30 meters) and/or at a distance that is a fraction (the fraction can be less than 1, 5, 10, 15, 20, 25, 30, 35, 40, 45, 50 percent) of the length or width of the indoor space.

Step 110 may be followed by step 120 of determining a location of the mobile device within an indoor space, based on a mapping between (a) locations within the indoor space, and (b) acoustic signatures associated with the locations. Each acoustic signature may include a frequency and an intensity parameter of acoustic beacon signals received at a location associated with the acoustic signature.

It should be noted that the location of the mobile device may be initially estimated and over time and/or following one or more event may be determined at a higher accuracy and/or a higher confidence level and/or a finer resolution. For example—the initial location of the mobile device (when first entering the indoor space) may be determined at a certain accuracy. Once the mobile device detected that it just passed a certain indoor transmitter—then the location of the mobile device may be determined at a higher accuracy—as the passing of the certain indoor transmitter verifies the location of the mobile device.

It should be noted that the acoustic signature received at a certain location may differ from the acoustic signature of the mapping. For example—movement-induced Doppler shifts may introduce a change between the transmission frequency of the acoustic beacon signal and the frequency of the received acoustic beacon signal. It should be noted that the frequency difference between adjacent acoustic beacon signals may exceed any Doppler shift in order to prevent ambiguities in mapping a received acoustic beacon signal to the transmission frequency of the acoustic beacon signal. It should be noted that when a dedicated tone is allocated for determining the Doppler shift—the spacing between adjacent tones may be smaller than the maximal Doppler shift.

It should be noted that the mapping that is utilized in step 120 may be generated in various manners and may be implemented in different manners. For example—the mapping may be generated by recording the acoustic signatures received by one or multiple mobile devices that are positioned at known locations within the indoor space. The multiple mobile devices may scan the indoor space while recording the acoustic signatures. The recorded acoustic signatures may be further processed to generate the mapping. The processing may include, machine learning processing, clustering, or any other method.

The mapping may include locations and one or more acoustic signatures sensed (by one or more mobile devices) at that location.

A mapping may be provided for any group of mobile devices—for all mobile devices or for any part of the entire population of mobile devices.

A mapping may be provided for mobile devices of a certain brand of manufacturer.

A mapping may be provided for mobile devices of a certain model of a certain manufacturer.

A mapping may be provided for mobile devices of a certain operating system, for one or more mobile devices of one or more users.

The mapping may be learnt during a learning process. The mapping may be updated over time—for example by adding acoustic signatures received by one of more users that may pass through the indoor space. Method 100 may include step 150 of providing feedback—and the feedback may be used to adjust the mapping and/or generate a new mapping (for example a mapping dedicated to the certain mobile device, and the like). An acoustic signature that is not included in a database of acoustic signatures may be added to the database (and associated with the location in which it was recorded)—or otherwise processed in any manner to update the mapping. It should be noted that step 120 may utilize multiple mappings—wherein different mappings may be associated with different groups of mobile devices.

Step 120 may be followed by step 130 of generating, by the mobile device, a location indication based on the determining of the at least location. The location indication may be provided even if the user is not in the middle of a navigation process—which may simplify the provision of the location indication. Step 130 may be executed even when the mobile device does not execute, at the time of the generating, a navigation application. Thus—the execution of a navigation process is not a prerequisite to the generating of the location indication. The location indication may be a visual indication (for example a symbol on a map, a text message), an audio indication, and the like.

Step 110 may be followed by step 140 of determining a movement parameter of the mobile device based on Doppler shifts of an acoustic signal. The acoustic signal may be included in one of the acoustic beacon signals. Alternatively—the acoustic signal may be dedicated to Doppler shift measurements. Assuming, for example, that certain acoustic beacon signals should be received (according to the mapping) at a certain location and that they were transmitted at a certain frequencies—then frequency difference between the certain frequencies and the received frequencies—are the Doppler shifts. Yet for another example—assuming that a certain tone is not used for location determination—but is dedicated for Doppler shift measurements—then its Doppler shift may be used to determine movement and also to compensate Doppler shifts in the tones of the acoustic beacon signals.

Step 140 may include step 146 of searching for a sign change of a Doppler shift associated with an acoustic beacon signal transmitted by a certain indoor transmitter. The sign change indicates that the mobile device that moved towards the indoor transmitter is now moving away from the indoor transmitter.

Step 146 may be followed by step 147 of determining that the mobile device passed over the certain indoor transmitter when the sign change of the Doppler shift occurred.

Step 146 may be followed by step 148 of starting to search for an acoustic beacon signals transmitted from the certain indoor transmitter following an occurrence of the sign change of the Doppler shift. The mobile device may receive multiple acoustic beacon signals from multiple indoor transmitters. The mobile device may select one or more acoustic beacon signals to use during the location determination—and ignore other (non-selected) acoustic beacon signals. Step 148 may include ignoring the acoustic beacon signals sent from the indoor transmitter that was just passed—and selecting an acoustic beacon signal from an indoor transmitter—that is expected to be positioned downstream to the mobile device.

Steps 110, 120, 130 and 140 may be repeated while the mobile device moves within the indoor space.

The acoustic signatures received by the mobile device while moving within the indoor space may be used for adjusting the mapping and/or for generating a new mapping.

Method 100 may include step 150 of transmitting feedback. This may include transmitting by the mobile phone location information and acoustic signature received by the mobile phone during at least a part of a duration within the indoor space. This information may be used for adjusting the mapping and/or for generating a new mapping.

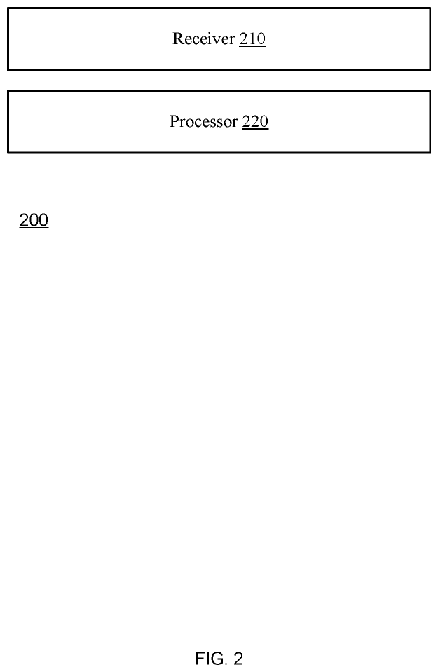

FIG. 2 illustrates an example of a mobile device 200.

The mobile device 200 may include a receiver 210 and a processor 220.

The receiver 210 is configured to receive acoustic beacon signals transmitted from indoor transmitters of known location; wherein adjacent indoor transmitters transmit acoustic beacon signals of different frequencies, the different frequencies are selected out of a group of frequencies within an acoustic frequency range that starts above 15 Kilohertz.

The processor 220 may be configured to determine a location of the mobile device within an indoor space, based on a mapping between (a) locations within the indoor space, and (b) acoustic signatures associated with the locations, wherein each acoustic signature comprises a frequency and an intensity parameter of acoustic beacon signals received at a location associated with the acoustic signature.

The mobile device may be configured to generate a location indication based on the determining of the at least location; wherein the generating is executed even when the mobile device does not execute, at the time of the generating, a navigation application.

The mobile device may be configured to determine a movement parameter of the mobile device based on Doppler shifts of the acoustic beacon signals.

The mobile device may be configured to search for a sign change of a Doppler shift associated with an acoustic beacon signal transmitted by a certain indoor transmitter.

The mobile device may be configured to determine that the mobile device passed over the certain indoor transmitter when the sign change of the Doppler shift occurred.

The mobile device may be configured to start to search for an acoustic beacon signals transmitted from the certain indoor transmitter following an occurrence of the sign change of the Doppler shift.

The mobile device may be configured to transmit by the mobile phone location information and acoustic signature received by the mobile phone during at least a part of a duration within the indoor space.

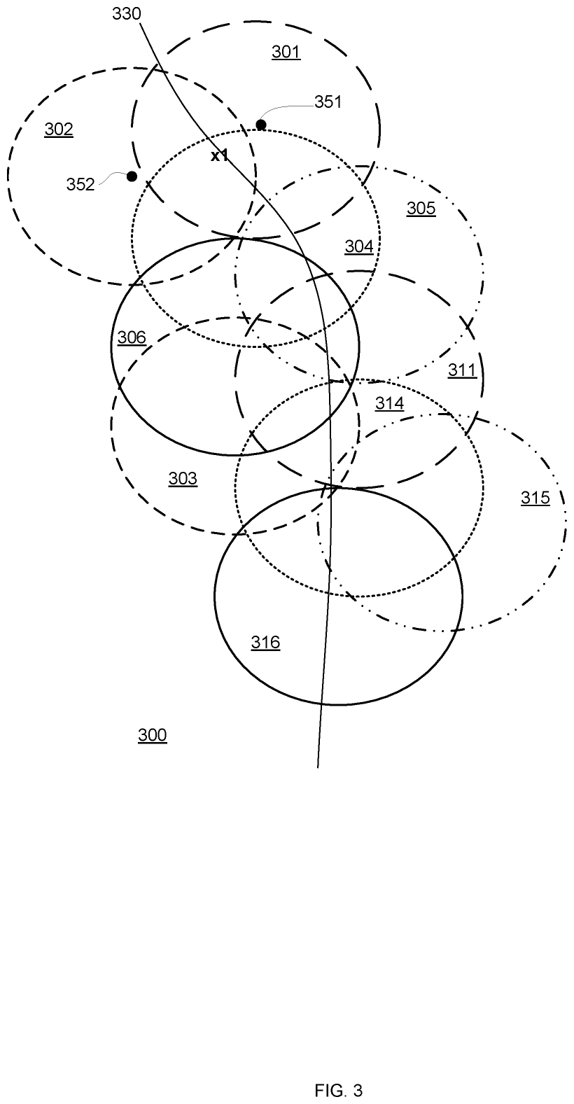

FIG. 3 illustrates an example of a path 300 of a mobile device within indoor space 300. FIG. 3 also illustrates reception areas (301, 302, 303, 304, 305, 306, 311, 314, 315, and 316) in which acoustic beacon signals transmitted by indoor transmitters are received. Only some of the reception areas are shown. Each location in the indoor space may be within the reception areas of at least two indoor transmitters. Two indoor transmitters 351 and 352 are shown—for simplicity of explanation only. In location x1 the mobile device may be too close to indoor transmitter 351 and any Doppler shift associated with that indoor transmitter may be ignored of. In addition—the Doppler shift sign may be reversed at that point.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner. The integrated circuit may be a system on chip, a general-purpose processor, a signal processor, an FPGA, a neural network integrated circuit, and the like.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for determining indoor position of a mobile device, the method comprises:
receiving, by the mobile device, acoustic beacon signals transmitted from indoor transmitters of known location; wherein adjacent indoor transmitters transmit acoustic beacon signals of different frequencies, the different frequencies are selected out of a group of frequencies within an acoustic frequency range that starts above 15 Kilohertz; and
determining a location of the mobile device within an indoor space, based on a mapping between (a) locations within the indoor space, and (b) acoustic signatures associated with the locations, wherein each acoustic signature comprises a frequency and an intensity parameter of acoustic beacon signals received at a location associated with the acoustic signature.

2. The method according to claim 1 comprising generating, by the mobile device, a location indication based on the determining of the at least location; wherein the generating is executed even when the mobile device does not execute, at the time of the generating, a navigation application.

3. The method according to claim 1 comprising determining a movement parameter of the mobile device based on Doppler shifts of the acoustic beacon signals.

4. The method according to claim 3 comprising searching for a sign change of a Doppler shift associated with an acoustic beacon signal transmitted by a certain indoor transmitter.

5. The method according to claim 4 comprising determining that the mobile device passed over the certain indoor transmitter when the sign change of the Doppler shift occurred.

6. The method according to claim 4 comprising starting to search for an acoustic beacon signals transmitted from the certain indoor transmitter following an occurrence of the sign change of the Doppler shift.

7. The method according to claim 1 comprising transmitting by the mobile phone location information and acoustic signature received by the mobile phone during at least a part of a duration within the indoor space.

8. A non-transitory computer program product for determining indoor position of a mobile device, the non-transitory computer program product stores instructions for:
receiving, by the mobile device, acoustic beacon signals transmitted from indoor transmitters of known location; wherein adjacent indoor transmitters transmit acoustic beacon signals of different frequencies, the different frequencies are selected out of a group of frequencies within an acoustic frequency range that starts above 15 Kilohertz; and
determining a location of the mobile device within an indoor space, based on a mapping between (a) locations within the indoor space, and (b) acoustic signatures associated with the locations, wherein each acoustic signature comprises a frequency and an intensity parameter of acoustic beacon signals received at a location associated with the acoustic signature.

9. The computer program product according to claim 8 that stores instructions for generating, by the mobile device, a location indication based on the determining of the at least location; wherein the generating is executed even when the mobile device does not execute, at the time of the generating, a navigation application.

10. The computer program product according to claim 8 that stores instructions for determining a movement parameter of the mobile device based on Doppler shifts of the acoustic beacon signals.

11. The computer program product according to claim 10 that stores instructions for searching for a sign change of a Doppler shift associated with an acoustic beacon signal transmitted by a certain indoor transmitter.

12. The computer program product according to claim 11 that stores instructions for determining that the mobile device passed over the certain indoor transmitter when the sign change of the Doppler shift occurred.

13. The computer program product according to claim 11 that stores instructions for starting to search for an acoustic beacon signals transmitted from the certain indoor transmitter following an occurrence of the sign change of the Doppler shift.

14. The computer program product according to claim 8 that stores instructions for transmitting by the mobile phone location information and acoustic signature received by the mobile phone during at least a part of a duration within the indoor space.

15. A mobile device that comprises a receiver and a processor;
wherein the receiver is configured to receive acoustic beacon signals transmitted from indoor transmitters of known location; wherein adjacent indoor transmitters transmit acoustic beacon signals of different frequencies, the different frequencies are selected out of a group of frequencies within an acoustic frequency range that starts above 15 Kilohertz; and
wherein the processor is configured to determine a location of the mobile device within an indoor space, based on a mapping between (a) locations within the indoor space, and (b) acoustic signatures associated with the locations, wherein each acoustic signature comprises a frequency and an intensity parameter of acoustic beacon signals received at a location associated with the acoustic signature.
